(19) United States
(12) Patent Application Publication
(10) Pub. No.: US 2013/0282877 A1
(43) Pub. Date: Oct. 24, 2013

(54) Apparatus and Method for Generating Bookmark in Streaming Service System

(71) Applicants: Ji-Eun Keum, Gyeonggi-do (KR); Ho-Jin Ha, Gangwon-do (KR); O-Hoon Kwon, Gyeonggi-do (KR); Jae-Yeon Song, Seoul (KR)

(72) Inventors: Ji-Eun Keum, Gyeonggi-do (KR); Ho-Jin Ha, Gangwon-do (KR); O-Hoon Kwon, Gyeonggi-do (KR); Jae-Yeon Song, Seoul (KR)

(73) Assignee: Samsung Electronics Co. Ltd, Gyeonggi-do (KR)

(21) Appl. No.: 13/978,516

(22) PCT Filed: Jan. 6, 2012
(86) PCT No.: PCT/KR2012/000132

§ 371 Date: Jul. 5, 2013

(30) Foreign Application Priority Data
Jan. 6, 2011 (KR) 1020110001205

(51) Int. Cl. H04L 29/06

(52) U.S. Cl. CPC H04L 65/601
USPC 709/219

(57) ABSTRACT

A method for generating and utilizing a bookmark in a streaming service system is provided. In a method for operating a server providing contents in an adaptive streaming service system, contents of a segment basis according to adaptive streaming is provided to a client. When a bookmark generate request message is received from the client, a bookmark generate request and segment identify information are transmitted to a bookmark server.

### TECHNICAL FIELD

The present invention relates to a streaming service system.

### BACKGROUND ART

As use of contents such as audio, video, etc. via on-line increases, importance of a technology for swiftly transmitting contents on a communication system emerges. With this trend, an adaptive streaming technology where a bit rate of contents is smoothly changed and transmission is made depending on an available transmission bandwidth or a change in the performance of a device of a user becomes the talking point. An adaptive streaming technology titled Dynamic Adaptive Streaming over HTTP (DASH) discussed by lots of standardization organizations is a transmission technology for allowing a user to use contents without a delay or disconnection by allowing User Equipment (UE) to selectively transmit units of contents divided into small segments based on HyperText Transfer Protocol (HTTP) depending on a circumstance.

Through the adaptive streaming technology, it is expected that swift contents transmission may be performed in accordance with a circumstance of a user. In addition, for convenience in the service use of a user, there is necessity of designating a specific portion of contents and reusing the same afterward, or providing a function which can be shared with other users. Therefore, an alternative for designating a specific portion of contents transmitted based on the adaptive streaming technology and sharing designated information with other users needs to be proposed.

### DISCLOSURE OF INVENTION

### Solution to Problem

An aspect of the present invention is to address at least the above-mentioned problems and/or disadvantages and to provide at least the advantages described below. Accordingly, an aspect of the present invention is to provide an apparatus and a method for designating a specific portion of contents transmitted based on an adaptive streaming technology in a streaming service system.

Another aspect of the present invention is to provide an apparatus and a method for sharing information that designates a specific portion of contents transmitted based on an adaptive streaming technology with other users in a streaming service system.

Still another aspect of the present invention is to provide an apparatus and a method for designating a specific portion of contents divided by segments in a streaming service system.

Yet another aspect of the present invention is to provide an apparatus and a method for sharing information that designates a specific portion of contents divided by segments in a streaming service system.

In accordance with an aspect of the present invention, a method for operating a server providing contents in an adaptive streaming service system is provided. The method includes providing contents of a segment basis according to adaptive streaming to a client, and when a bookmark generate request message is received from the client, transmitting a bookmark generate request and segment identify information to a bookmark server.

In accordance with another aspect of the present invention, a method for operating a client in an adaptive streaming service system is provided. The method includes reproducing contents of a segment basis according to adaptive streaming, and when recognizing a user's bookmark generate command during reproduction of the contents, transmitting a bookmark generate request message to a contents server.

In accordance with still another aspect of the present invention, a method for operating a server managing a bookmark in an adaptive streaming service system is provided. The method includes receiving segment identify information and a bookmark generate request from a contents server, and generating a bookmark that designates the segment.

In accordance with further another aspect of the present invention, a server apparatus for providing contents in an adaptive streaming service system is provided. The server apparatus includes a controller for controlling to provide contents of a segment basis according to adaptive streaming to a client, and a communication unit for, when a bookmark generate request message is received from the client, transmitting a bookmark generate request and segment identify information to a bookmark server.

In accordance with further yet another aspect of the present invention, a client apparatus in an adaptive streaming service system is provided. The client apparatus includes a controller for reproducing contents of a segment basis according to adaptive streaming, and a communication unit for, when recognizing a user's bookmark generate command during reproduction of the contents, transmitting a bookmark generate request message to a contents server.

In accordance with still further another aspect of the present invention, a server apparatus for managing a bookmark in an adaptive streaming service system is provided. The server apparatus includes a communication unit for receiving segment identify information and a bookmark generate request from a contents server, and a controller for generating a bookmark that designates the segment.

Other aspects, advantages and salient features of the invention will become apparent to those skilled in the art from the following detailed description, which, taken in conjunction with the annexed drawings, discloses exemplary embodiments of the invention.

### BRIEF DESCRIPTION OF DRAWINGS

The above and other aspects, features and advantages of certain exemplary embodiments of the present invention will be more apparent from the following description taken in conjunction with the accompanying drawings in which:

FIG. 1 is a view illustrating a procedure for generating a bookmark in a streaming service system according to an exemplary embodiment of the present invention;

FIG. 2 is a view illustrating a procedure for generating a bookmark in a streaming service system according to an exemplary embodiment of the present invention;

FIG. 3 is a view illustrating a procedure for using a bookmark in a streaming service system according to an exemplary embodiment of the present invention;

FIG. 4 is a view illustrating a procedure for using a bookmark in a streaming service system according to an exemplary embodiment of the present invention;

FIG. 5 is a view illustrating a procedure for using a bookmark in a streaming service system according to an exemplary embodiment of the present invention;

FIG. 6 is a view illustrating a procedure for sharing a bookmark in a streaming service system according to an exemplary embodiment of the present invention;

FIG. 7 is a block diagram illustrating a client apparatus in a streaming service system according to an exemplary embodiment of the present invention; and

FIG. 8 is a block diagram illustrating a contents server and a bookmark server in a streaming service system according to an exemplary embodiment of the present invention.

Throughout the drawings, like reference numerals will be understood to refer to like parts, components and structures.

### BEST MODE FOR CARRYING OUT THE INVENTION

Exemplary embodiments of the present invention provide a technology for designating a specific portion of contents transmitted based on an adaptive streaming technology and sharing designated information with other users in a streaming service system.

The present invention relates to an apparatus and a method for generating and using a bookmark in a streaming service system. In the following description, exemplary embodiments of the present invention will be described. In addition, though the present invention uses titles of objects defined by 3rd Generation Partnership Project (3GPP), Moving Picture Experts Group (MPEG), and Open IPTV Forum (OIPF) for convenience in description, these standards and titles do not limit the scope of the present invention but applicable to a system of a similar technical background, of course.

In a system according to an exemplary embodiment of the present invention, a transmission server providing contents divides contents into a plurality of segments and stores the same. At this point, the size of each segment is defined using a predetermined time length or a byte size. For an adaptive streaming technology, the transmission server stores a plurality of segment files having different bit rates with respect to each segment. Therefore, when transmitting each segment, the transmission server selects an optimized bit rate with consideration of a user's channel state, etc. and transmits a segment file corresponding to the selected bit rate.

In addition, the transmission server according to an exemplary embodiment of the present invention generates information designating a specific portion of contents divided by segments according to a user's request. Hereinafter, in the present invention, ‘information designating a specific portion of contents’ is denoted by a ‘bookmark’. The bookmark may be stored in the transmission server or stored in a separate bookmark server. The bookmark may have various structures. For example, a specific structure of the bookmark may be Table 1, Table 2, or Table 3 below.

TABLE 1
Bookmark Segment URL
(i.e.,: http://www.aService.com/aMovie/LQ/Seg10.3)

TABLE 2
Bookmark Segment URL, Time offset

TABLE 3
Bookmark ID list of selected representation, Period, Time offset

That is, as shown in Table 1 or Table 2, the bookmark may include only a Uniform Resource Locator (URL) of a relevant segment, or include the URL and a time offset in the corresponding segment. When segment identify information having the same discrimination as the segment URL exists, the segment URL may be replaced by the identify information. In addition, the time offset may be replaced by a byte offset.

In addition, according to an exemplary embodiment of the present invention, as in the structure of Table 3, a combination of a list of representation identifiers where a scene as viewed by a user is selected, an identifier of a period containing time information, time offset information indicating a point in a the period may be defined as one bookmark. In case of Table 3, even when contents are reproduced via a bookmark afterward, an environment at the time of bookmark generation may be reproduction. That is, reproduction may be performed from a scene indicated by a combination of representations recorded on the bookmark. For a specific example, in the case where a pitcher scene and a catcher scene in a scene of a baseball game are formed of different representations, when two representations are being reproduced, a list of relevant selected representations may be included in a bookmark.

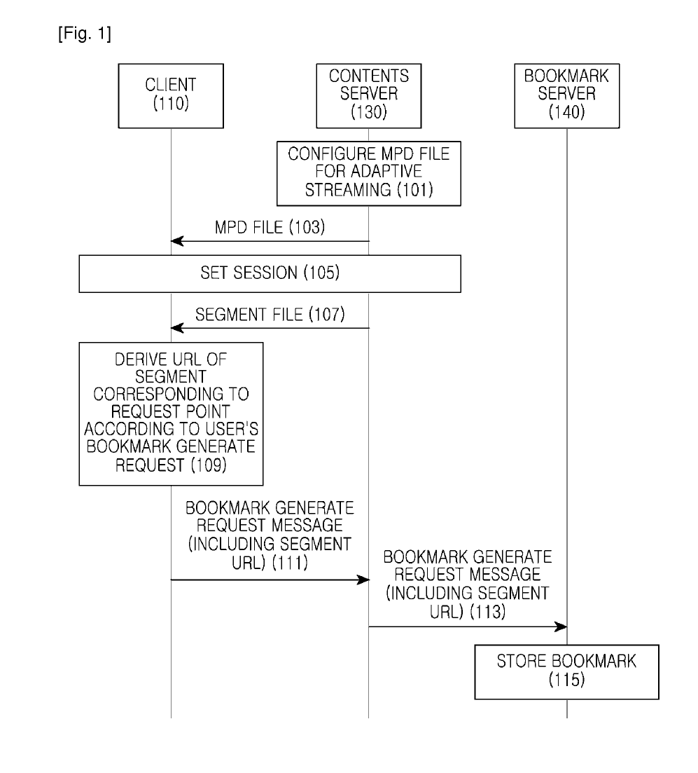

FIG. 1 is a view illustrating a procedure for generating a bookmark in a streaming service system according to an exemplary embodiment of the present invention. FIG. 1 illustrates an embodiment of a case where a bookmark is identified and managed by one segment of contents.

Referring to FIG. 1, a contents server 130 configures a Media Presentation Description (MPD) file for supporting adaptive streaming of contents in step 101. The MPD file serves as a meta data file for segments of contents, and includes information required by a client 110 to receive a streaming service, such as a time position on contents regarding segment files, a URL, a size, etc. The contents server 130 is an object providing segment files of contents, and may be denoted by a ‘HTTP server’.

The contents server 130 transmits the MPD file for reproducing adaptive streaming-based contents to the client 110 in step 103. Here, the client 110 denotes User Equipment (UE) that receives a streaming service. The client 110 may be a mobile terminal, a fixed device, an Internet Protocol Television (IPTV), etc. The client 110 performs communication with the contents server 130 via a wireless access network or a wired network.

The client 110 that has received the MPD file sets a session for transmission of a segment using information included in the MPD file in step 105. In addition, the contents server 130 transmits a segment file to the client 110 in step 107. In FIG. 1, though the session setting of step 105 and the segment file transmission of step 107 are performed one time, the session setting and the segment file transmission may be performed for each segment.

The client 110 derives a URL of a segment corresponding to a request point according to a user's bookmark generate request in step 109. In other words, the client 110 recognizes the use's bookmark generate request during reproduction of contents formed of segments, and determines a segment reproduced at the point where the bookmark generate request has occurred, and then determines the URL of the segment.

Accordingly, the client 110 transmits a bookmark generate request message to the contents server 130 in step 111. Subsequently, the contents server 130 that has received the bookmark generate request message transmits a bookmark generate request message requesting storing of a bookmark to a bookmark server 140 in step 113. Here, the bookmark generate request message transmitted in step 111 and step 113 includes the URL of the segment determined in step 109. However, according to an exemplary embodiment of the present invention, the URL may be replaced by different identify information of the segment. According to an exemplary embodiment of the present invention, the bookmark generate request message may include a list of selected representation identifiers, period information containing time information, time offset information indicating a point in the period.

The bookmark server 140 generates and stores a bookmark including the URL of the segment in step 115. At this point, the bookmark is identified and stored for each client, and includes at least one of the URL of a segment, identify information of a segment, a time offset, a byte offset, etc. According to an exemplary embodiment of the present invention, the bookmark may include ID list of selected representation, a period, and a time offset. In addition, to support a bookmark share function, the bookmark server 140 may store whether an access of other clients to a bookmark is possible, in other words, store information representing whether the bookmark is sharable. A client having an access right may be set as all clients, at least one specific client, a specific client group, etc. The at least one client having the access right may be designated by the client 110 that generates the bookmark, or by basic setting of a system. The client having the access right may be designated via a user Identifier (ID), client device identify information, etc. Hereinafter, for convenience in description, the present invention denotes ‘information regarding a client having the access right for a specific bookmark’ by ‘share setting information’. According to an exemplary embodiment of the present invention, the share setting information may be stored in the contents server 130.

In FIG. 1, though the contents server 130 and the bookmark server 140 have been illustrated as separate objects, the contents server 130 and the bookmark server 140 may be configured as one object according to an exemplary embodiment of the present invention. For example, the contents server 130 may include the bookmark server 140. In this case, step 113 may be omitted and step 115 may be performed by the contents server 130.

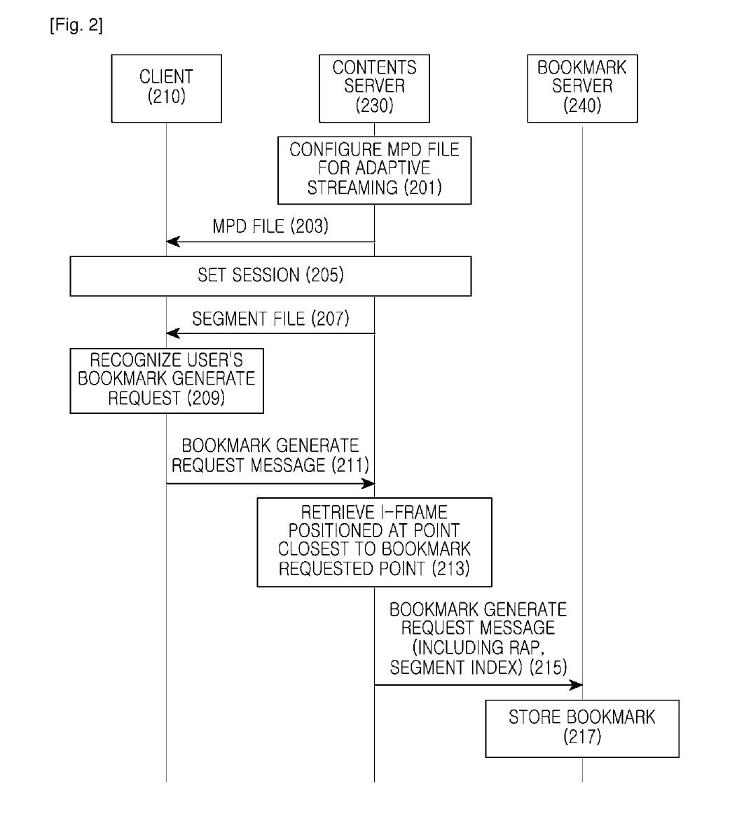

FIG. 2 is a view illustrating a procedure for generating a bookmark in a streaming service system according to an exemplary embodiment of the present invention.

Referring to FIG. 2, a contents server 230 configures an MPD file for supporting adaptive streaming of contents in step 201. The MPD file serves as a meta data file for segments of contents, and includes information required by a client 210 to receive a streaming service, such as a time position on contents regarding segment files, a URL, a size, etc. The contents server 230 is an object providing segment files of contents, and may be denoted by a ‘HTTP server’.

The contents server 230 transmits the MPD file for reproducing adaptive streaming-based contents to the client 210 in step 203. Here, the client 210 denotes User Equipment (UE) that receives a streaming service. The client 210 may be a mobile terminal, a fixed device, etc. The client 210 performs communication with the contents server 230 via a wireless access network or a wired network.

The client 210 that has received the MPD file sets a session for transmission of a segment using information included in the MPD file in step 205. In addition, the contents server 230 transmits a segment file to the client 210 in step 207. In FIG. 2, though the session setting of step 205 and the segment file transmission of step 207 are performed one time, the session setting and the segment file transmission may be performed for each segment.

The client 210 recognizes a user's bookmark generate request in step 209. Accordingly, the client 210 transmits a bookmark generate request message to the contents server 230 in step 211. According to an exemplary embodiment of the present invention, the bookmark generate request message may include at least one of a list of selected representation identifiers, period information containing time information, time offset information indicating a point in the period.

The contents server 230 that has received the bookmark generate request message determines an offset of a bookmark by determining a portion which the user desires to bookmark in step 213. For example, as illustrated in FIG. 2, the contents server 230 retrieves an I-frame of a closest position from a point where the bookmark generation has been requested. The I-frame is a frame having time information of contents, and becomes a Random Access Point (RAP) of the contents. That is, unlike the embodiment illustrated in FIG. 1, since a bookmark generate request of the client 210 does not include information indicating a specific segment, the contents server 230 determines a portion which the user desires to bookmark using the point at which the bookmark generate request has occurred.

The contents server 230 that has retrieved the I-frame transmits a bookmark generate request message requesting storing of the bookmark to a bookmark server 240 in step 215. Here, the bookmark generate request message transmitted in step 215 includes identify information (for example, index, URL) of a segment reproduced when a bookmark generate request occurs, and offset information indicating the I-frame determined in step 213. Here, the offset information may be a byte offset or a time offset. That is, the even when information regarding a segment does not exist in the bookmark generate request message transmitted in step 211, the contents server 230 providing segment files may know the segment reproduced when the bookmark generate request message is received. Therefore, the contents server 230 transmits a bookmark generate request message including identify information of the segment and offset information. According to an exemplary embodiment of the present invention, the bookmark generate request message may includes at least one of a list of selected representation identifiers, period information containing time information, time offset information indicating a point in the period.

The bookmark server 240 generates and stores a bookmark including identify information of the segment and the offset information in step 217. At this point, the bookmark is divided and stored for each client and includes at least one of the URL of a segment, identify information of a segment, a time offset, and a byte offset. According to an exemplary embodiment of the present invention, the bookmark may include an ID list of selected representation, a period, and a time offset. In addition, to support a bookmark share function, the bookmark server 240 may store whether an access of other clients to a bookmark is possible, in other words, store information representing whether the bookmark is sharable. A client having an access right may be set as all clients, one specific client, a specific client group, etc. A client that can share each bookmark may be designated by the client 210 that generates the bookmark, or by basic setting of a system. The client having the access right may be designated via a user Identifier (ID), client device identify information, etc. According to an exemplary embodiment of the present invention, the share setting information may be stored in the contents server 230.

In FIG. 2, though the contents server 230 and the bookmark server 240 have been illustrated as separate objects, the contents server 230 and the bookmark server 240 may be configured as one object according to an exemplary embodiment of the present invention. For example, the contents server 230 may include the bookmark server 240. In this case, step 215 may be omitted and step 217 may be performed by the contents server 230.

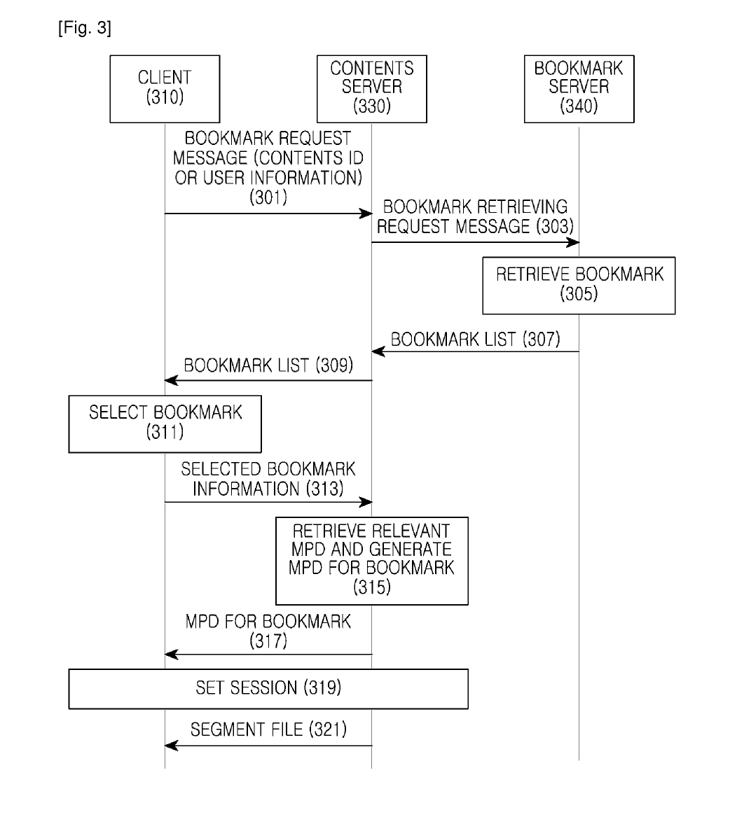

FIG. 3 is a view illustrating a procedure for using a bookmark in a streaming service system according to an exemplary embodiment of the present invention.

Referring to FIG. 3, a client 310 transmits a bookmark request message to a contents server 330 in step 301. At this point, the client 310 designates specific contents to request a bookmark for the contents. Accordingly, the bookmark request message includes at least one of identify information of the contents and a user's identify information. According to an exemplary embodiment of the present invention, the identify information of the contents may be replaced by identify information of a segment.

The contents server 330 that has received the bookmark request message transmits a bookmark retrieving request message to a bookmark server 340 in step 303. The bookmark retrieving request message includes at least one of the identify information of the contents and the user's identify information included in the bookmark request message.

The bookmark server 340 that has received the bookmark retrieving request message retrieves at least one bookmark requested by the bookmark retrieving request message from stored bookmarks in step 305. That is, the bookmark server 340 retrieves a bookmark corresponding to identify information using identify information of requested contents or user's identify information. For example, in the case where the user's identify information is included, the bookmark server 340 retrieves all bookmarks generated by the relevant user.

The bookmark server 340 transmits at least one retrieved bookmark to the contents server 330 in step 307. That is, the bookmark server 340 transmits at least one bookmark corresponding to the contents, at least one bookmark corresponding to the user, or at least one bookmark corresponding to the contents and the user to the contents server 330. In addition, the contents server 330 transmits the bookmark list to the client 310 in step 309.

The client 310 that has received the bookmark list selects one of at least one bookmark included in the bookmark list according to the user's command in step 311. That is, the client 310 informs the user of at least one bookmark included in the bookmark list via a display unit, and determines one bookmark selected by the user's manipulation.

The client 310 that has selected the one bookmark transmits information regarding the selected bookmark to the contents server 330 in step 313. Here, the transmitting of the information regarding the selected bookmark is to request an MPD file for reproducing contents after a portion designated by the selected bookmark. For convenience in description, the present invention denotes the ‘MPD file for reproducing contents after the portion designated by the bookmark’ by an ‘MPD file for a bookmark’.

The contents server 330 that has received information regarding the selected bookmark retrieves an MPD file of the contents including the portion designated by the selected bookmark, and generates an MPD file for a bookmark corresponding to the selected bookmark using the MPD file in step 315. That is, the contents server 330 generates the MPD file for the contents and generates the MPD file for the bookmark including only information regarding segments after the portion designated by the selected bookmark. Subsequently, the contents server 330 transmits the MPD file for the bookmark to the client 310 in step 317.

The client 310 that has received the MPD file for the bookmark sets a session for transmission of a segment using information included in the MPD file for the bookmark in step 319. In other words, the client 310 sets a session for reception of segments after the point at which bookmark has been made by the selected bookmark. In addition, the contents server 330 transmits a segment file to the client 310 in step 321.

In FIG. 3, though the contents server 330 and the bookmark server 340 have been illustrated as separate objects, the contents server 330 and the bookmark server 340 may be configured as one object according to an exemplary embodiment of the present invention. For example, the contents server 330 may include the bookmark server 340. In this case, step 303 and step 307 may be omitted and step 305 may be performed by the contents server 330.

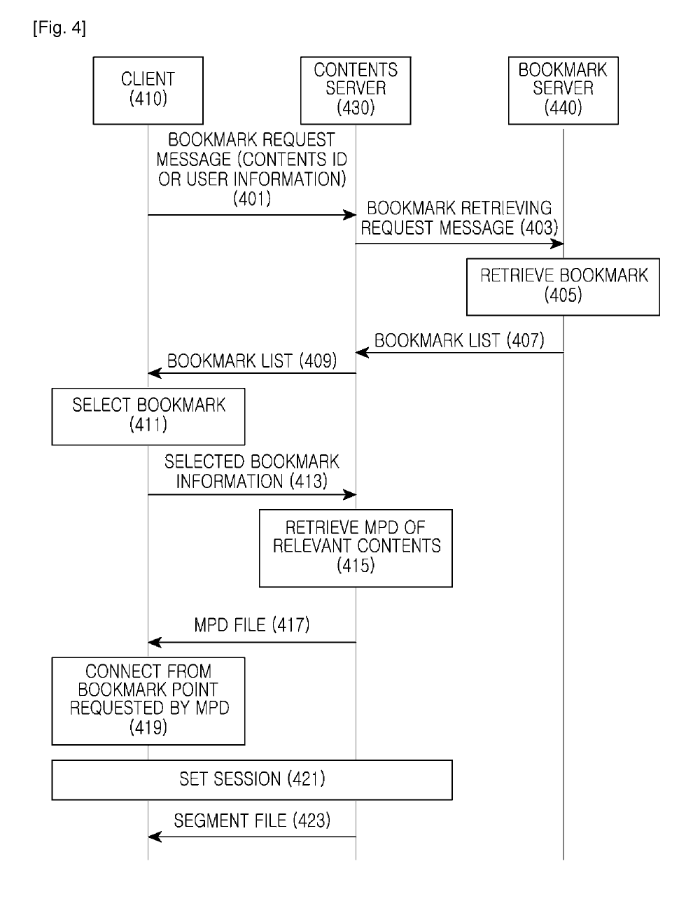

FIG. 4 is a view illustrating a procedure for using a bookmark in a streaming service system according to an exemplary embodiment of the present invention.

Referring to FIG. 4, a client 410 transmits a bookmark request message to a contents server 430 in step 401. At this point, the client 410 designates specific contents to request a bookmark for the contents. Accordingly, the bookmark request message includes at least one of identify information of the contents and a user's identify information. According to an exemplary embodiment of the present invention, the identify information of the contents may be replaced by identify information of a segment.

The contents server 430 that has received the bookmark request message transmits a bookmark retrieving request message to a bookmark server 340 in step 403. The bookmark retrieving request message includes at least one of the identify information of the contents and the user's identify information included in the bookmark request message.

The bookmark server 440 that has received the bookmark retrieving request message retrieves at least one bookmark requested by the bookmark retrieving request message from stored bookmarks in step 405. That is, the bookmark server 440 retrieves a bookmark corresponding to identify information using identify information of requested contents or user's identify information. For example, in the case where the user's identify information is included, the bookmark server 440 retrieves all bookmarks generated by the relevant user.

The bookmark server 440 transmits at least one retrieved bookmark to the contents server 430 in step 407. That is, the bookmark server 440 transmits at least one bookmark corresponding to the contents, at least one bookmark corresponding to the user, or at least one bookmark corresponding to the contents and the user to the contents server 430. In addition, the contents server 430 transmits the bookmark list to the client 410 in step 409.

The client 410 that has received the bookmark list selects one of at least one bookmark included in the bookmark list according to the user's command in step 411. That is, the client 410 informs the user of at least one bookmark included in the bookmark list via a display unit, and determines one bookmark selected by the user's manipulation.

The client 410 that has selected the one bookmark transmits information regarding the selected bookmark to the contents server 430 in step 413. Here, the transmitting of the information regarding the selected bookmark is to request an MPD file of contents including the portion designated by the selected bookmark.

The contents server 430 that has received information regarding the selected bookmark retrieves the MPD file of the contents including the portion designated by the selected bookmark in step 415. In addition, the contents server 430 transmits the MPD file to the client 410 in step 417.

The client 410 that has received the MPD file retrieves information of the portion designated by the selected bookmark from the MPD file in step 419. In other words, the client 410 extracts information regarding segments after the portion designated by the selected bookmark from the MPD file.

The client 410 sets a session for transmission of a segment using the information extracted from the MPD file in step 421. In other words, the client 410 sets a session for reception of segments after the point at which bookmark has been made by the selected bookmark. In addition, the contents server 430 transmits a segment file to the client 410 in step 423.

In FIG. 4, though the contents server 430 and the bookmark server 440 have been illustrated as separate objects, the contents server 430 and the bookmark server 440 may be configured as one object according to an exemplary embodiment of the present invention. For example, the contents server 430 may include the bookmark server 440. In this case, step 403 and step 407 may be omitted and step 405 may be performed by the contents server 430.

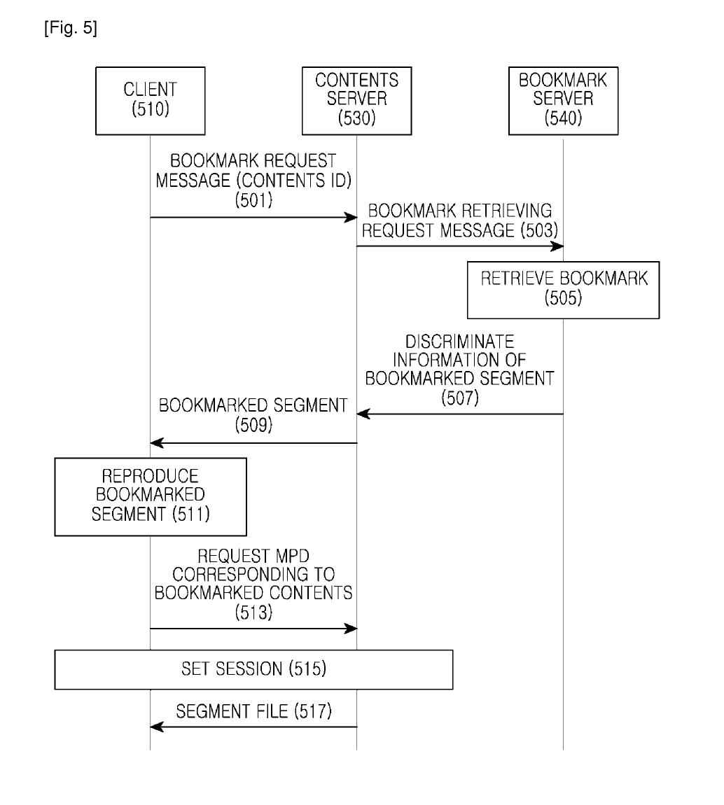

FIG. 5 is a view illustrating a procedure for using a bookmark in a streaming service system according to an exemplary embodiment of the present invention.

Referring to FIG. 5, a client 510 transmits a bookmark request message to a contents server 530 in step 501. At this point, the client 510 designates specific contents to request a bookmark for the contents. Accordingly, the bookmark request message includes identify information of the contents. According to an exemplary embodiment of the present invention, the identify information of the contents may be replaced by identify information of a segment.

The contents server 530 that has received the bookmark request message transmits a bookmark retrieving request message to a bookmark server 540 in step 503. The bookmark retrieving request message includes the identify information of the contents included in the bookmark request message.

The bookmark server 540 that has received the bookmark retrieving request message retrieves at least one bookmark requested by the bookmark retrieving request message from stored bookmarks in step 505. That is, the bookmark server 540 retrieves a bookmark corresponding to identify information using identify information of requested contents.

The bookmark server 540 that has retrieved the bookmark transmits identify information of a segment including the portion designated by the retrieved bookmark to the contents server 530 in step 507. For example, the identify information of the segment may include the URL of the segment. For convenience in description, the present invention denotes the ‘segment including the portion designated by the bookmark’ by a ‘bookmarked segment’.

The contents server 530 that has received the identify information of the bookmarked segment transmits the bookmarked segment to the client 510 in step 509. Accordingly, the client 510 reproduces the bookmarked segment in step 511. In addition, the client 510 requests an MPD file of bookmarked contents in step 513.

The client 510 sets a session for transmission of a segment in step 515. In other words, the client 510 sets a session for reception of segments after the point bookmarked by the selected bookmark.

The contents server 530 transmits a segment file to the client 510 in step 517.

In FIG. 5, after the MPD file request of step 513, step of transmitting an MPD file of requested contents at the contents server 530 may be added. In this case, the contents server 530 retrieves an MPD file of the requested contents and transmits the MPD file to the client 510.

The bookmark server 540 transmits identify information of the segment including the portion designated by the retrieved bookmark in step 507 of FIG. 5. At this point, a plurality of bookmarks may be retrieved. At this point, according to an exemplary embodiment of the present invention, the bookmark server 540 may select one bookmark according to a predetermined rule and provide identify information of a segment bookmarked by the selected bookmark. According to an exemplary embodiment of the present invention, the bookmark request transmitted in step 501 may include information indicating a specific bookmark. In this case, the bookmark server 540 may select one bookmark according to an instruction of the client 510 and provide identify information of a segment bookmarked by the selected bookmark. According to an exemplary embodiment of the present invention, in the case where the plurality of bookmarks are retrieved, the bookmark server 540 does not observe the procedure illustrated in FIG. 5 and may provide a bookmark list as illustrated in FIG. 3 or FIG. 4.

In FIG. 5, though the contents server 530 and the bookmark server 540 have been illustrated as separate objects, the contents server 530 and the bookmark server 540 may be configured as one object according to an exemplary embodiment of the present invention. For example, the contents server 530 may include the bookmark server 540. In this case, step 503 and step 507 may be omitted and step 505 may be performed by the contents server 530.

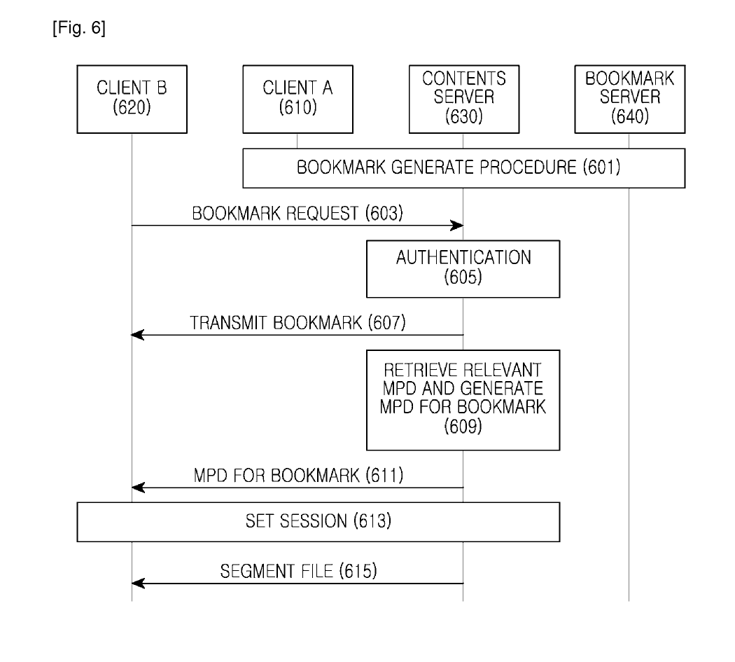

FIG. 6 is a view illustrating a procedure for sharing a bookmark in a streaming service system according to an exemplary embodiment of the present invention.

Referring to FIG. 6, a client A 610, a contents server 630, a bookmark server 640 perform a bookmark generate procedure in step 601. The bookmark generate procedure denotes a procedure where the client A 610 requests bookmark generation that designates a specific portion of contents, and accordingly, the contents server 630 and the bookmark server 640 generate and store a bookmark designating the specific portion. For example, the bookmark generate procedure of step 601 may observer the procedure illustrated in FIG. 1 or FIG. 2.

A client B 620 requests the contents server 630 to transmit a bookmark generated by the client A 610 in step 603. That is, the client B 620 transmits a message requesting sharing of a bookmark generated by a different client, not itself. Here, the message requesting the sharing includes information indicating that the different client is the client A 610.

The contents server 630 performs an authentication procedure for the client B 620 in step 605. In other words, the contents server 630 determines whether the client B 620 has a right for accessing the bookmark of the client A 610. That is, in the bookmark generate procedure of step 601, according to a request of the client A 610 or basic setting of a system, at least one specific client or client group having an access right with respect to a generated bookmark, that is, at least one specific client or client group with which a bookmark is to be shared is designated. At this point, the client having the access right may be designated by a user ID, client device identify information, etc. That is, the bookmark generate procedure of step 601 includes a procedure for setting an access right with respect to a bookmark. Therefore, the contents server 630 determines whether the client B 620 has a right for accessing the bookmark of the client A 610 with reference to the sharing set information generated in step 601. In FIG. 6, the authentication procedure of step 605 is performed by the contents server 630. However, according to an exemplary embodiment of the present invention, the authentication procedure may be performed by the bookmark server 640. In case of FIG. 6, the present invention assumes that the client B 620 has a right for accessing at least one bookmark of the client A 610.

The contents server 630 transmits a corresponding bookmark to the client B 620 in step 607. In other words, the contents server 630 transmits at least one bookmark of the client A 610 with respect to which the client B 620 has an accessing right to the client B 620.

The contents server 630 retrieves an MPD file of contents including a portion designated by the bookmark and generates an MPD file for a bookmark of the selected bookmark using the MPD file in step 609. That is, the contents server 630 generates an MPD file for the contents, and generates an MPD file for a bookmark including only information for segments after a portion designated by the selected bookmark. In addition, the contents server 630 transmits the MPD file for the bookmark to the client B 620 in step 611.

The client B 620 that has received the MPD file for the bookmark sets a session for transmission of a segment using information included in the MPD file for the bookmark in step 613. In addition, the contents server 630 transmits a segment file to the client B 620 in step 615.

The contents server 630 transmits a sharable bookmark to the client B 620 in step 607 of FIG. 6. At this point, step for selecting, at the client B 620, a bookmark and informing the contents server 630 of the selected bookmark may be added.

In FIG. 6, after the authentication of step 605, a procedure for requesting the bookmark server 640 to transmit a sharable bookmark and receiving the bookmark at the contents server 630 may be added. In this case, the contents server 630 requests the bookmark server 640 to transmit a sharable bookmark, and the bookmark server 640 retrieves the requested bookmark, and then transmits the retrieved bookmark to the contents server 630.

In FIG. 6, step 609 to step 615 serve as a bookmark use procedure and observe the procedure illustrated in FIG. 3. According to an exemplary embodiment of the present invention, step 609 to step 615 may be replaced by the bookmark use procedure illustrated in FIG. 4 or FIG. 5.

In FIG. 6, though the contents server 630 and the bookmark server 640 have been illustrated as separate objects, the contents server 630 and the bookmark server 640 may be configured as one object according to an exemplary embodiment of the present invention. For example, the contents server 630 may include the bookmark server 640.

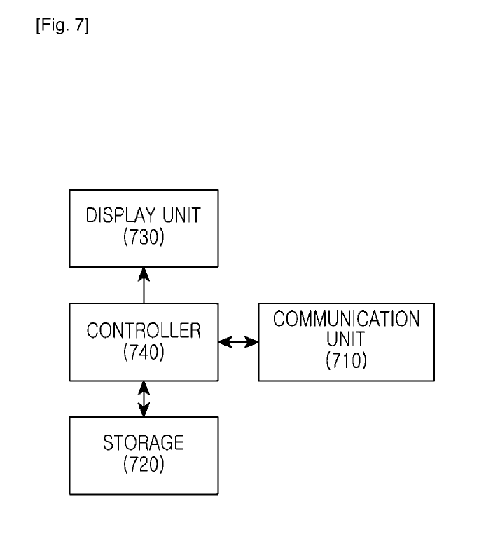

FIG. 7 is a block diagram illustrating a client apparatus in a streaming service system according to an exemplary embodiment of the present invention.

Referring to FIG. 7, a client device includes a communication unit 710, a storage 720, a display unit 730, and a controller 740.

The communication unit 710 recovers streaming data, that is, contents data from a signal received via a channel, converts transmission data into a signal, and transmits the same via the channel. Here, the channel may be a wired channel or a wireless channel. In case of the wireless channel, the communication unit 710 converts a Radio Frequency (RF) signal received via an antenna into a baseband signal, processes a physical layer according to the standard of a communication system, and recovers a bit line via demodulation.

The storage 720 stores a basic program for operating the client device, setting information required for communication, a program and setting information for a user interface, etc. In addition, the storage 720 provides stored data under control of the controller 740. The display unit 730 displays state information occurring during an operation of the client device, numbers, characters and images occurring during execution of an application program, etc. For example, the display unit 730 displays image contents. That is, the display unit 730 displays image data provided from the controller 740 via a visual screen. For example, the display 730 may be a Liquid Crystal Display (LCD), an Organic Light-Emitting Diode (OLED), etc.

The controller 740 controls overall functions of the client device. For example, the controller 740 generates image data from streaming data received via the communication unit 710, and provides the image data to the display unit 730. More particularly, according to an exemplary embodiment of the present invention, the controller 740 controls a function for generating, using, and sharing a bookmark usable in the adaptive streaming service. For example, the controller 740 controls to operate as the client illustrated in FIGS. 1 to 6. Detailed description is provided below.

The operation of the controller 740 for generating the bookmark is as follows. According to an exemplary embodiment of the present invention, the controller 740 recognizes a user's bookmark generate command while reproducing a segment according to an adaptive streaming service, derives the URL of the segment that is being reproduced, and transmits a bookmark generate request message to a contents server via the communication unit 710. According to an exemplary embodiment of the present invention, the controller 740 does not derive the URL of the segment and may transmit a bookmark generate request message not containing the URL.

The operation of the controller 740 for using the bookmark is described below. The controller 740 transmits a bookmark request message to the contents server via the communication unit 710. Here, the bookmark request message includes at least one of identify information of contents, identify information of a segment, and a user's identify information. According to an exemplary embodiment of the present invention, a bookmark list may be received from the contents server in response to the bookmark request message. In this case, the controller 740 displays the bookmark list via the display unit 730, determines the user's selection, and transmits the selected bookmark to the contents server. Accordingly, an MPD file for a bookmark is received from the contents server, and the controller 740 sets a session for reception of segments after the bookmarked point using the MPD file for the bookmark. According to an exemplary embodiment of the present invention, after the controller 740 transmits the selected bookmark, an MPD file of contents including a portion designated by the selected bookmark may be received from the contents server. In this case, the controller 740 extracts information regarding a segment after the portion designated by the selected bookmark from the MPD file, and sets a session for reception of segments after a bookmarked point. According to an exemplary embodiment of the present invention, a bookmarked segment may be received from the contents server in response to the bookmark request message. In this case, the controller 740 reproduces the bookmarked segment, and requests an MPD file corresponding to bookmarked contents via the communication unit 710. Accordingly, when the MPD file of the corresponding contents is received, the controller 740 sets a session for reception of segments after the bookmarked point.

The operation of the controller 740 for sharing of the bookmark is described below. The controller 740 designates at least one client having an access right with respect to a bookmark generated when generating a bookmark. At this point, the at least one client having the access right may be designated a user ID, client device identify information, etc. To share a bookmark generated by a different client, the controller 740 transmits a message requesting sharing of the bookmark generated by the different client to the contents server. Accordingly, when a sharable bookmark and an MPD file for a bookmark corresponding to the sharable bookmark are received from the contents server, the controller 740 sets a session for reception of segments after a bookmarked point using the MPD file for the bookmark.

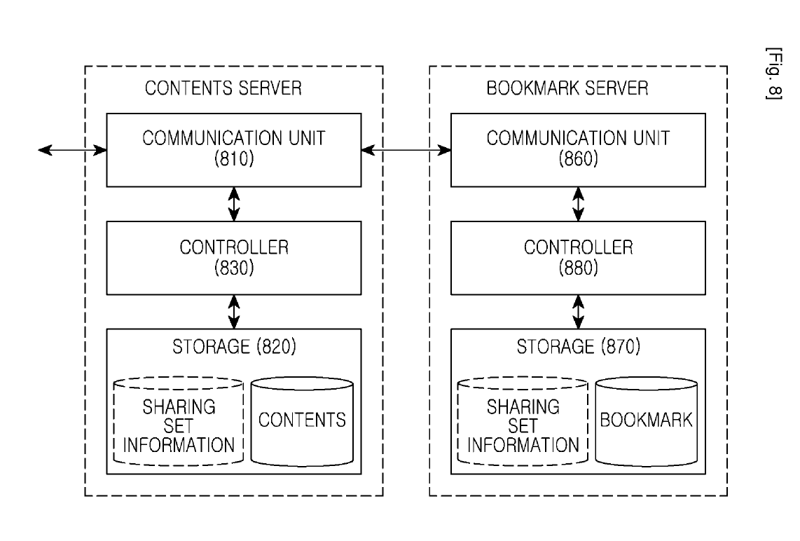

FIG. 8 is a block diagram illustrating a contents server and a bookmark server in a streaming service system according to an exemplary embodiment of the present invention.

Referring to FIG. 8, the contents server includes a communication unit 810, a storage 820, and a controller 830. The bookmark server includes a communication unit 860, a storage 870, and a controller 880.

The communication unit 810 of the contents server provides an interface for performing communication with other objects in a network. The storage 820 of the contents server stores a basic program for operating the contents server, and more particularly, stores contents to be provided to clients. Here, the contents are stored in the form of a plurality of segment files in order to support the adaptive streaming. In addition, the storage 820 of the contents server may store sharing set information.

The controller 830 of the contents server controls overall functions of the contents server. For example, the controller 830 transmits contents to clients via the communication unit 810. At this point, depending on the adaptive streaming, the controller 830 determines a bit rate optimized for a corresponding client, and transmits a segment file corresponding to the bit rate. More particularly, according to an exemplary embodiment of the present invention, the controller 830 controls a function for generating, using, and sharing a bookmark usable in the adaptive streaming service. For example, the controller 830 controls to operate as the contents server illustrated in FIGS. 1 to 6. Specific description is made below.

The operation of the controller 830 for generating the bookmark is descried below. According to an exemplary embodiment of the present invention, when a bookmark generate request message including identify information (for example, a URL, an index) of a segment is received from a client, the controller 830 transmits the bookmark generate request message including the identify information of the segment to the bookmark server via the communication unit 810. According to an exemplary embodiment of the present invention, when a bookmark generate request message not including identify information (for example, a URL, an index) of a segment is received from a client, the controller 830 determines a portion which a user desires to bookmark by retrieving an I-frame of a closest position from the point where a bookmark generation has been requested, and when a bookmark generate request occurs, transmits a bookmark generate request message including identify information (for example, an index, a URL) of a segment that is being reproduced and offset information indicating a determined I-frame to the bookmark server via the communication unit 810.

The operation of the controller 830 for using the bookmark is described below. When a bookmark request message is received from a client, the controller 830 transmits a bookmark retrieving request message to the bookmark server. Here, the bookmark request message includes at least one of identify information of contents, identify information of a segment, and a user' identify information. After that, according to an exemplary embodiment of the present invention, the controller 830 transmits a bookmark list received from the bookmark server to the client, when selected bookmark information is received from the client, generates an MPD file for a bookmark corresponding to the selected bookmark, and transmits the MPD file for the bookmark to the client. According to an exemplary embodiment of the present invention, when the selected bookmark is received, the controller 830 retrieves an MPD file of contents including a portion designated by the selected bookmark, and transmits the MPD file to the client. According to an exemplary embodiment of the present invention, when identify information of a bookmarked segment is received from the bookmark server in response to the bookmark retrieving request message, the controller 830 transmits the bookmarked segment to the client. Additionally, when an MPD file of the bookmarked contents is requested, the controller 830 retrieves the MPD file of the bookmarked contents, and transmits the MPD file to the client.

The operation of the controller for sharing the bookmark is described below. The controller 830 generates sharing set information according to designate information of a client having an access right included in a bookmark generate request message received from a client, and stores the sharing set information in the storage 820. In addition, when sharing for a bookmark of a different client is requested by a client, the controller 830 determines whether it has an access right depending on the sharing set information. When determining that it has the access right, the controller 830 obtains at least one sharable bookmark from the bookmark server, and transmits the at least one sharable bookmark to the client that has requested the sharing. In addition, the controller 830 generates an MPD file for a bookmark corresponding to the sharable bookmark, and transmits the MPD file for the bookmark to the client that has requested the sharing. According to an exemplary embodiment of the present invention, in the case where the sharing set information is not stored in the contents server, the controller 830 requests the bookmark server to perform authentication when sharing is requested, and transmits at least one sharable bookmark depending on the authentication result of the bookmark server.

The communication unit 860 of the bookmark server provides an interface for performing communication with other objects in a network. The storage 870 of the bookmark server stores a basic program for operating the bookmark server, and more particularly, bookmarks of clients. The bookmarks are identified and stored for each client, and each bookmark includes at least one of the URL of a segment, identify information of a segment, a time offset, and a byte offset. In addition, the storage 870 of the bookmark server may store sharing set information.

The controller 880 of the bookmark server controls overall functions of the bookmark server. More particularly, according to an exemplary embodiment of the present invention, the controller 880 controls a function for generating, using, and sharing a bookmark usable in the adaptive streaming service. For example, the controller 880 controls to operate as the bookmark server illustrated in FIGS. 1 to 6. Specific description is made below.

The operation of the controller 880 for generating the bookmark is described below. When a bookmark generate request message including at least one of identify information (for example, a URL, an index) of a segment and offset information is received from the contents server, the controller 880 generates a bookmark, and stores the bookmark in the storage 870. At this point, the bookmark is identified and stored for each client, and includes at least one of the URL of a segment, identify information of a segment, a time offset, and a byte offset.

The operation of the controller 880 for using the bookmark is described below. According to an exemplary embodiment of the present invention, when a bookmark retrieving request message including at least one of identify information of contents, identify information of a segment, a user's identify information is received from the contents server, the controller 880 retrieves at least one bookmark using at least one of the identify information of the contents, the identify information of the segment, the user's identify information, and transmits the at least one bookmark to the contents server. According to an exemplary embodiment of the present invention, the controller 880 transmits identify information regarding a bookmarked segment to the contents server in response to the bookmark retrieving request message.

The operation of the controller 880 for sharing the bookmark is described. The controller 880 generates sharing set information according to designate information of a client having an access right included in a bookmark generate request message received from the contents server, and stores the generated sharing set information in the storage 870. In addition, when authentication for a bookmark is requested by the contents server, the controller 880 determines whether it has an access right depending on the sharing set information. When determining that it has the access right, the controller 880 transmits at least one sharable bookmark to the contents server.

In FIG. 8, though the contents server and the bookmark server have been illustrated as separate objects, the contents server and the bookmark server may be configured as one object according to an exemplary embodiment of the present invention. For example, the contents server may include the bookmark server. In this case, the storage 820 of the contents server stores bookmark information, the controller 830 of the contents server performs all of the function of the controller 880 of the bookmark server, and a signaling procedure between the contents server and the bookmark server may be replaced by an internal information exchange procedure.

The streaming service system may provide a bookmark function in the adaptive streaming service by generating a bookmark on a segment basis and generating MPD based on the bookmark. Furthermore, the streaming service system may use a bookmark generated by a different client by defining a sharing procedure of a bookmark.

Although the invention has been shown and described with reference to certain exemplary embodiments thereof, it will be understood by those skilled in the art that various changes in form and details may be made therein without departing from the spirit and scope of the invention as defined by the appended claims and their equivalents. Therefore, the scope of the present invention should not be limited to the above-described embodiments but should be determined by not only the appended claims but also the equivalents thereof.

1. A method for operating a server providing contents in an adaptive streaming service system, the method comprising:
providing contents divided by segments according to adaptive streaming to a client; and
transmitting a bookmark generate request and a segment identity information to a bookmark server in response to a bookmark generate request message being received from the client.

2. The method of claim 1, wherein the bookmark generate request message comprises at least one of a list of selected representation identifiers, period information containing time information, time offset information indicating a point in a period, identity information of contents, a user's identity information, or identity information of a segment.

3. The method of claim 1, further comprising:
in response to the bookmark generate request message being received, determining an offset of a bookmark using a point at which the bookmark generate request message has been received.

4. The method of claim 1, wherein transmitting the bookmark generate request and the segment identity information to the bookmark server comprises:
transmitting the bookmark generate request, the segment identity information, and the offset information.

5. The method of claim 1, further comprising:
in response to a bookmark generate request message being, received from the client, sending, a request to the bookmark server to retrieve a bookmark; and
transmitting one of a book mark list, a Media Presentation Description (MPD) file for a bookmark for reproducing contents after a portion designated by a bookmark selected by the client, an MPD file of contents comprising a portion designated by a bookmark selected by the client, or a bookmarked segment to the client.

6. The method of claim 1, further comprising:
generating sharing set information according to designate information of a client having an access right included in the bookmark generate request message;
in response to a message requesting sharing of a bookmark of a second client being received from a first client, determining whether the first client has an access right with respect to the bookmark of the second client using the sharing set information;
in response to determining that the first client has the access right, transmitting at least one sharable bookmark to the first client.

7. A method for operating a client in an adaptive streaming service system, the method comprising:
reproducing contents of a segment basis according to adaptive streaming; and
in response to recognizing a user's bookmark generate command during reproduction of the contents, transmitting a bookmark generate request message to a contents server.

8. The method of claim 7, wherein the bookmark generate request message comprises at least one of a list of selected representation identifiers, period information containing time information, time offset information indicating a point in a the period, identity information of contents, a user's identity information, or identity information of a segment.

9. The method of claim 7, further comprising, after recognizing the user's bookmark generate command and in response to the bookmark generate command occurring, determining identify information of a segment that is being reproduced.

10. The method of claim 7, further comprising:
transmitting a bookmark request message requesting a bookmark generated in advance to the contents server;
receiving one of a book mark list, a Media Presentation Description (MPD) file for a bookmark for reproducing contents after a portion designated by a bookmark selected by a user, an MPD file of contents comprising a portion designated by a bookmark selected by a user, or a bookmarked segment.

11. The method of claim 7, wherein the bookmark generate request message comprises designate information of a client having an access right with respect to a bookmark.

12. The method of claim 7, further comprising:
transmitting a message requesting sharing of a bookmark of a different client to the contents server;
receiving at least one bookmark of the different client and an MPD file for a bookmark corresponding to the at least one bookmark; and
setting a session for reception of at least one segment after a portion designated by the at least one bookmark using the MPD file for the bookmark.

13. A method for operating a server managing a bookmark in an adaptive streaming service system, the method comprising:
receiving segment identity information and a bookmark generate request from a contents server; and
generating a bookmark that designates the segment.

14. The method of claim 13, wherein the bookmark comprises an IDentifier (ID) list of selected representation, a period, and a time offset.

15. The method of claim 13, further comprising:
receiving at least one of a user's identity information, identity information of contents, and identity information of a segment, or a bookmark retrieving request from the contents server;
retrieving a bookmark corresponding to at least one of the user's identity information, the identity information of the contents, and the identity information of the segment; and
after retrieving the bookmark, transmitting one of a bookmark list comprising at least one retrieved bookmark and an identify information of a bookmarked segment to the contents server.

16. A server capable of providing contents in an adaptive streaming service system, the server comprising:
a communication unit; and
a controller configured to control the communication unit to:
provide contents divided by segments according to adaptive streaming to a client; and
transmit a bookmark generate request and a segment identity information to a bookmark server in response to a bookmark generate request message being received from the client.

17. The server of claim 16, wherein the bookmark generate request message comprises at least one of a list of selected representation identifiers, period information containing time information, time offset information indicating a point in a period, identity information of contents, a user's identity information, or identity information of a segment.

18. The server of claim 16, wherein the controller is configured to, in response to the bookmark generate request message being received, determine an offset of a bookmark using a point at which the bookmark generate request message has been received.

19. The server of claim 16, wherein in transmitting the bookmark generate request and the segment identity information to the bookmark server, the controller is configured to control the communication unit to transmit the bookmark generate request, the segment identity information, and the offset information.

20. The server of claim 16, wherein the controller is configured to control the communication unit to:
in response to a bookmark generate request message being received from the client, send a request to the bookmark server to retrieve a bookmark; and
transmit one of a book mark list, a Media Presentation Description (MPD) file for a bookmark for reproducing contents after a portion designated by a bookmark selected by the client, an MPD file of contents comprising a portion designated by a bookmark selected by the client, or a bookmarked segment to the client.
